(19) United States
(12) Patent Application Publication
(10) Pub. No.: US 2021/0323175 A1
(43) Pub. Date: Oct. 21, 2021

(54) TWO-STAGE EJECTOR

(71) Applicant: INSTITUT NATIONAL DES SCIENCES APPLIQUEES DE TOULOUSE (INSA TOULOUSE), Toulouse (FR)

(72) Inventors: Stéphane Orieux, Montlaur (FR); Lucien Baldas, Castanet-Tolosan (FR)

(73) Assignee: INSTITUT NATIONAL DES SCIENCES APPLIQUEES DE TOULOUSE (INSA TOULOUSE), Toulouse (FR)

(21) Appl. No.: 17/260,947

(22) PCT Filed: Jul. 23, 2019
(86) PCT No.: PCT/EP2019/069798

§ 371 Date: Jan. 15, 2021

(30) Foreign Application Priority Data
Jul. 27, 2018 (FR) 1857017

(51) Int. Cl. B25J 15/06

(52) U.S. Cl. CPC B25J 15/0675

(57) ABSTRACT

This two-stage ejector comprises a body (16) including:
a compressed air intake (E);
a compressed air injection nozzle (17) placed downstream of the air intake;
a central duct (18); and
an outlet mixer (19).

The injection nozzle (17), the central duct (18) and the outlet mixer (19) are disposed along an axis (X-X′) of the ejector so that the ends of the axial duct are respectively spaced apart from the nozzle and from the mixer so as to form a first and a second suction zone (23, 25) that communicates with a single common air suction chamber (21).

The present invention relates to an ejector of the Venturi effect type for producing a vacuum, particularly for vacuum gripper systems.

The fields of application of vacuum gripper systems are numerous and varied. Venturi effect ejectors may for example be used in the field of the automobile industry, in pneumatic conveying, etc.

They use a suction pad whereof the inner volume is connected to the ejector itself connected to a compressed air source and that includes inside one or more air injection nozzles delimiting downstream an expansion chamber that communicates with an air suction chamber connected to the inner volume of the suction pad.

It is known, in the prior art, single-stage ejectors and multi-stage ejectors.

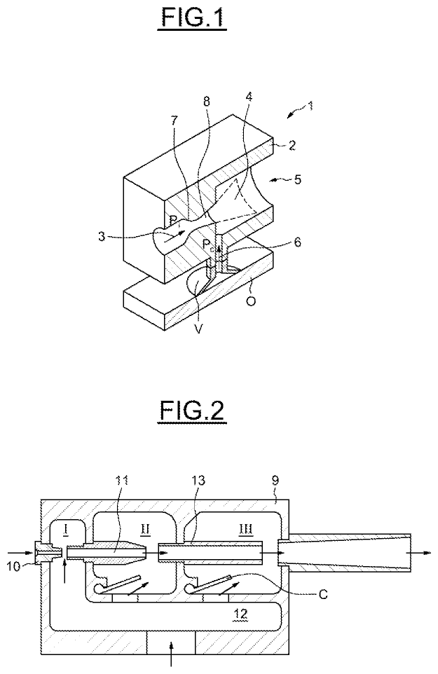

FIG. 1 shows an example of embodiment of a single-stage Venturi ejector.

The ejector, designated by the general numerical reference 1, comprises a body 2 provided inside with a compressed air injection nozzle 3 intended to be connected to a compressed air source, a mixing chamber 4 provided with an air outlet 5 and a suction duct 6 that communicates with the inner volume of a suction pad V pressed firmly against an object O to be handled.

The air injection nozzle has a converging—diverging shape and includes a narrowing section 7 and an expansion chamber 8 placed downstream of the narrowing section 7.

The supply nozzle 3, the expansion chamber 8, and the mixing chamber 4 constitute successive volumes placed along a longitudinal central axis of the ejector.

The suction duct 6 delimits for its part a cylindrical volume whereof the central axis extends substantially perpendicular to the longitudinal axis of the ejector.

Single-stage ejectors of this type are advantageous in so far as they are robust and have an operating reliability related to the absence of moveable parts.

However, the performances of ejectors are characterised by two parameters that depend on the pressure of the supply gas, namely the maximum vacuum level, reached when the suction flow rate is cancelled, in the case of a suction pad tightly applied against the object to be handled, and the maximum suction flow rate, obtained when the suction duct is opened to the atmosphere.

The first parameter is directly related to the gripping force that can be used at the suction pad, whereas the second parameter determines the vacuum speed or the capacity to grasp porous objects.

For the porous objects, indeed, the increase in the suction flow rate is obtained by increasing the diameter of the mixing chamber. But this is done to the detriment of the vacuum level.

Single-stage ejectors make it possible to obtain a higher vacuum level, but to the detriment of a low compressed air flow rate. They also make it possible to obtain a high suction flow rate and a consecutively rapid emptying time, but to the detriment of a low vacuum level.

Another solution, which makes it possible to obtain a high vacuum level and a low emptying time, consists in using a multi-stage ejector, as illustrated in FIG. 2, which shows an axisymmetric ejector with three stages I, II and III.

The ejector includes a body 9 provided with an air injection nozzle 10 connected to a compressed air source, a mixing chamber 11 that delimits with the nozzle 10 an expansion chamber that communicates with a suction chamber 12 and whereof the outlet constitutes an air injection nozzle for the second stage II, whereof the mixing chamber 13 constitutes a nozzle for the third stage III.

At each successive stage, the suction flow rate increases whereas the maximum vacuum level generated reduces.

Check valves C are interposed between the stages II and III and the suction chamber 12.

Each stage provides a different function.

At the beginning of the gripping cycle, the suction flow rate is maximum. All of the stages are used. Then the check valves close successively depending on the negative pressure generated by each stage and on the pressure that changes in the suction chamber during the sequence of the gripping cycle.

With this type of multi-stage ejector, significant suction capacities are obtained at low vacuum level, while maintaining the capacity of generating a significant vacuum level at zero suction flow rate.

However, this solution is cumbersome and requires the presence of check valves, which makes the multi-stage ejectors sensitive to pollutions and complex to produce.

Therefore, the aim of the invention is to overcome the drawbacks related to single-stage and multi-stage ejectors and aims to propose an ejector without moveable parts, capable of providing a vacuum level similar to single-stage ejectors but having performances in terms of suction flow rate of the same magnitude as multi-stage ejectors.

Therefore, the subject matter of the invention is a two-stage ejector produced as a single part, comprising a body including:
a compressed air intake;
a compressed air injection nozzle placed downstream of the air intake;
a central duct; and
an outlet mixer,

the injection nozzle, the central duct and the outlet mixer being disposed along an axis of the ejector, so that the ends of the central duct are respectively spaced apart from the nozzle and from the mixer so as to form a first and a second suction zone that communicates with a single common air suction chamber.

According to another feature, the suction chamber communicates with a suction duct intended to be connected to a volume of air to be sucked and that extends perpendicular to the axis of the ejector.

Also according to another feature, the air injection nozzle comprises a cylindrical supply duct comprising a narrowing section and an expansion chamber placed downstream of the narrowing section.

Advantageously, the central duct is cylindrical.

Preferably, this central duct comprises an intake having an inner peripheral surface with convex axial section and converging in the direction of the compressed air flow.

Furthermore, the central duct may include an air outlet having an outer peripheral surface with bevelled axial section.

In one embodiment, the outlet mixer has a diameter increasing in the direction of the air flow.

For example, the central duct is attached to the body by at least one support.

In various embodiments, the diameter of the central duct is between the outlet diameter of the injection nozzle and the intake diameter of the downstream mixer and the length of the central duct is between one and ten times the inside diameter thereof.

As regards the nozzle, the diameter of the narrowing section must be the smallest diameter of the passage sections of the fluid along the general axis of the ejector and the diameter of the outlet of the injection nozzle is between the diameter of the narrowing section of the nozzle and the intake diameter of the central duct.

Again, the subject matter of the invention is a vacuum lifting device comprising a lifting tube, a two-stage ejector such as defined above, and a valve supplying said ejector and controlling the lifting tube.

In other words, an ejector supplied through the valve, itself controlled by an operator, makes it possible to regulate the vacuum level of the tube. Thus, the venting of the tube and the use of a turbine pump with strong suction, are no longer necessary.

Other aims, features and advantages of the invention will become apparent upon reading the following description given only by way of non-limiting example, and made with reference to the appended drawings wherein:

FIGS. 1 and 2, already mentioned, illustrate respectively the structure of a single-stage ejector and of a multi-stage ejector according to the prior art;

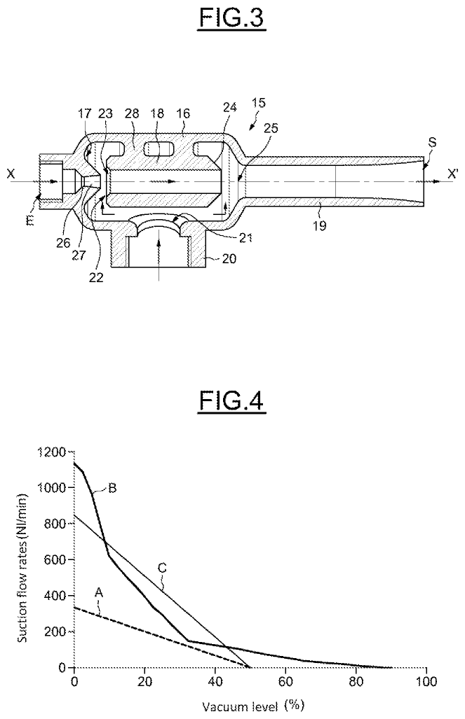

FIG. 3 illustrates the structure of a two-stage ejector in accordance with the invention; and

FIG. 4 illustrates the relative performances of a single-stage ejector, of a multi-stage ejector and of a two-stage ejector in accordance with the invention, in terms of suction flow rate and of vacuum level, these three ejectors having the same consumption of compressed air at identical supply pressure.

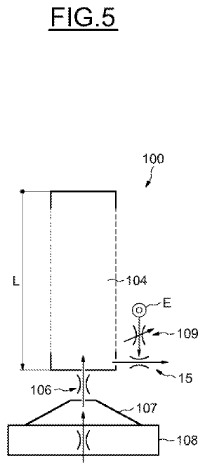

FIG. 5 illustrates the structure of a lifting device in accordance with the invention.

FIG. 3 shows a two-stage ejector in accordance with the invention, designated by the general numerical reference 15.

This ejector 15 comprises a body 16, produced as a single part, comprising an intake E equipped with a thread and intended to be connected to a compressed air supply source, for example at a pressure in the order of 5 bars conventionally used in industrial environments, and a gas outlet S.

Inside, the body 16 comprises a compressed air injection nozzle 17, disposed downstream of the intake E, a central duct 18 and an outlet mixer 19.

The nozzle 17, the central duct 18 and the outlet mixer 19 are successively placed between the intake E and the outlet S along the general axis X-X′ of the ejector.

Moreover, the body 16 includes a suction duct 20 provided with an internal thread for connecting the ejector 15 to the inner volume to be sucked of a suction pad (not shown).

The suction duct 20 extends perpendicular to the axis X-X′ and is located opposite the median portion of the central duct. It delimits with this and the inner wall of the body a single common suction chamber 21 for the two stages of the ejector 15.

As can be seen, the nozzle 17 is spaced apart from the upstream end 22 of the central duct so as to form an expansion zone 23 for the first stage.

Moreover, the downstream end 24 of the central duct 18 is spaced apart from the outlet mixer 19 so as to form an expansion zone 25 for the second stage.

The expansion chambers 23 and 25 constitute suction zones that communicate with the common suction chamber 21.

The suction nozzle 17 includes a cylindrical supply duct comprising a narrowing section 26 and an expansion chamber 27 located downstream of the narrowing section 26.

The inner peripheral surface of the upstream end 22 of the central duct 18 is converging and includes a longitudinal section of convex shape so as to guide the compressed gas mixed with the suction gas towards the inside of the duct.

On the downstream side, the outer peripheral surface of the downstream outlet 24 of the central duct 18 has a bevelled longitudinal section so as to channel the suction gas into the expansion zone.

Moreover, the outlet mixer 19 has a globally cylindrical shape but has an inside diameter increasing in the direction of the outlet S in order to facilitate the ejection of the air flow towards the outside in subsonic flow.

As previously indicated, the assembly of the ejector is produced as a single part. The central duct 18 is connected to the body 16 by one or more supports 28, here two in number, integrally formed with the body.

Advantageously, the diameter of the central duct is between the outlet diameter of the expansion chamber 27 and the intake diameter of the mixer 19.

The length of this central tube is advantageously between one and ten times the inside diameter thereof.

As regards the injection nozzle 17, the diameter of the narrowing section 26 is the smallest diameter of the passage sections of the fluid along the general axis X-X′ of the ejector.

The diameter of the outlet of the injection nozzle 17 is for its part advantageously between the diameter of the narrowing section 26 and the inside diameter of the upstream end 22 of the central duct 18.

By way of non-limiting example, the ejector may have the following characteristic dimensions:
outlet diameter of the injection nozzle: 4 mm
narrowing section diameter of the nozzle: 3 mm
diameter of the central duct: 8 mm
length of the central duct: 35 mm
intake diameter of the downstream mixer: 10.5 mm

FIG. 4 illustrates the performances of the two-stage ejector that has just been described.

In this figure, the curve A corresponds to a single-stage ejector according to the prior art, the curve B corresponds to a conventional multi-stage ejector and the curve C corresponds to a two-stage ejector in accordance with the invention. These three ejectors have the same compressed air consumption at identical supply pressure.

The results appearing in FIG. 4 are obtained for a supply pressure in the order of 5 bars.

As can be seen, the ejector according to the invention makes it possible to obtain a vacuum level of 50%, similar to the vacuum level obtained by means of a single-stage ejector.

Conversely, it makes it possible to obtain a more than doubled suction flow rate in relation to a single-stage model, and this with a structure devoid of moveable parts.

FIG. 5 illustrates the structure of a lifting device 100 in accordance with the invention.

The lifting device 100 is capable of handling, inclining, lifting a wide range of loads.

For this, it comprises a lifting tube 104, of length L proportional to the pressure contained in said tube.

More specifically, it is the negative pressure in the lifting tube 104 that makes it possible to grip an object 108 via a suction pad 107.

It should be noted that when no object is gripped, the presence of a lower check valve 106 makes it possible to maintain a sufficient negative pressure at the lifting tube 104.

The lifting device 100 further comprises a valve 109, controlled by an operator, and capable of supplying the two-stage ejector 15 with the compressed air coming from the intake E. This makes it possible, by the high suction flow rate of the two-stage ejector 15, to rapidly empty the lifting tube 104, which gives the system a good dynamic reactivity.

In other terms, the lifting device 100 makes it possible to lift a load without time limit while generating less noise.

In addition, this configuration of the lifting device 100 makes it possible, if the two-stage ejector 15 is located inside a vacuum chamber, to significantly reduce the frictions of the air.

The performances of the system are therefore improved.

1. Two-stage ejector produced as a single piece, characterised in that it comprises a body (16) including:
a compressed air intake (E);
a compressed air injection nozzle (17) placed downstream of the air intake;
a central duct (18); and
an outlet mixer (19),
the injection nozzle (17), the central duct (18) and the outlet mixer (19) being disposed along an axis (X-X′) of the ejector so that the ends of the axial duct are respectively spaced apart from the nozzle and from the mixer so as to form a first and a second suction zone (23, 25) that communicates with a single common air suction chamber (21).

2. Ejector according to claim 1, wherein the suction chamber communicates with a suction duct (20) intended to be connected to a suction air volume and that extends perpendicular to the axis of the ejector.

3. Ejector according to claim 1, wherein the air injection nozzle comprises a cylindrical supply duct comprising a narrowing section (26) and an expansion chamber (27) placed downstream of the narrowing section.

4. Ejector according to claim 1, wherein the central duct (18) is cylindrical.

5. Ejector according to claim 4, wherein the central duct comprises an intake (22) having an inner peripheral surface with convex axial section and converging in the direction of the compressed air flow.

6. Ejector according to claim 4, wherein the central duct comprises an air outlet (24) having an outer peripheral surface with bevelled axial section.

7. Ejector according to claim 1, wherein the outlet mixer (19) has a diameter increasing in the direction of the air flow.

8. Ejector according to claim 1, wherein the central duct (18) is attached to the body by at least one support (28).

9. Ejector according to claim 1, wherein the diameter of the central duct is between the outlet diameter of the injection nozzle (17) and the intake diameter of the mixer (19) and the length of the central tube is between one and ten times the inside diameter thereof.

10. Ejector according to claim 9, wherein the diameter of a narrowing section of the air injection nozzle is the smallest diameter of the passage sections of the fluid along the general axis (X-X′) of the ejector and the diameter of the outlet of the injection nozzle is between the diameter of the narrowing section and the inside diameter of the upstream end of the central duct.

11. Vacuum lifting device (100) comprising a lifting tube (104), a two-stage ejector (15) according to claim 1, a valve (109) supplying said ejector (15) and controlling the lifting tube (104).
